(19) United States
(12) Patent Application Publication
(10) Pub. No.: US 2014/0378259 A1
(43) Pub. Date: Dec. 25, 2014

(54) TRANSMISSION SYSTEM OF HYBRID ELECTRIC VEHICLE

(71) Applicant: Hyundai Motor Company, Seoul (KR)

(72) Inventors: Baekyu KIM, Suwon-Si (KR); SungGon BYUN, Anyang-si (KR); Hyunsup KIM, Seoul (KR); Hee Ra LEE, Anyang-si (KR); Insup KIM, Anyang-si (KR); Seok Joon KIM, Yongin-si (KR); Chulmin AHN, Busan (KR)

(73) Assignee: Hyundai Motor Company, Seoul (KR)

(21) Appl. No.: 14/145,373

(22) Filed: Dec. 31, 2013

(30) Foreign Application Priority Data
Jun. 24, 2013 (KR) 10-2013-0072277

(51) Int. Cl. B60K 6/42

(52) U.S. Cl. CPC B60K 6/42; Y10S 903/902
USPC 475/5; 180/65.22; 903/902

(57) ABSTRACT

A transmission system of a hybrid electric vehicle may include: an input shaft connected to an engine; first and second motor/generators disposed on a transmission housing; a first planetary gear set disposed on the input shaft and having three rotation elements, wherein one rotation element is connected to the transmission housing, another rotation element is connected to the first motor/generator, and the other rotation element is connected to the input shaft; a second planetary gear set disposed on the input shaft and having three rotation elements, wherein one rotation element is connected to the transmission housing, another rotation element is connected to the second motor/generator, and the other rotation element is operated as an output element; an output gear connected to the other rotation element of the second planetary gear set; and a first clutch selectively connecting the input shaft to the output gear.

### CROSS-REFERENCE TO RELATED APPLICATION

The present application claims priority of Korean Patent Application Number 10-2013-0072277 filed Jun. 24, 2013, the entire contents of which application is incorporated herein for all purposes by this reference.

### BACKGROUND OF INVENTION

1. Field of Invention

The present invention relates to a transmission system of a hybrid electric vehicle. More particularly, the present invention relates to a transmission system of a hybrid electric vehicle that can achieve EV mode, continuous mode and parallel mode including direct-coupling and OD.

2. Description of Related Art

Generally, a hybrid vehicle is a vehicle which uses two different power sources efficiently.

Such a hybrid electric vehicle typically uses an engine and a motor/generator.

The hybrid electric vehicle uses the motor/generator having relatively better low-speed torque characteristics as a main power source at a low-speed and uses an engine having relatively better high-speed torque characteristics as a main power source at a high-speed.

Since the hybrid electric vehicle stops operation of the engine using the fossil fuel and uses the motor/generator at a low-speed region, fuel consumption may be improved and exhaust gas may be reduced.

The power transmission system of a hybrid electric vehicle is classified into a single-mode type and a multi-mode type.

A torque delivery apparatus such as clutches and brakes for shift control is not necessary, but fuel consumption is high due to deterioration of efficiency at a high-speed region and an additional torque multiplication device is required for being applied to a large vehicle according to the single-mode type.

Since the multi-mode type has high efficiency at the high-speed region and is able to multiply torque autonomously, the multi-mode type can be applied to a full size vehicle.

Therefore, the multi-mode type instead of the single-mode type is applied as the power transmission system of a hybrid electric vehicle and is also under continuous investigation.

The power transmission system of the multi-mode type includes a plurality of planetary gear sets, a plurality of motor/generators operated as a motor and/or a generator, a plurality of torque delivery apparatus controlling rotation elements of the planetary gear sets, and a battery used as a power source of the motor/generators.

The power transmission system of the multi-mode type has different operating mechanisms depend on connections of the planetary gear sets, the motor/generators, and the torque delivery apparatus.

In addition, the power transmission system of the multi-mode type has different features such a durability, power delivery efficiency, and size depend on the connections of the planetary gear sets, the motor/generators, and the torque delivery apparatus. Therefore, designs for the connection structure of the power transmission system of a hybrid electric vehicle are also under continuous investigation to achieve robust and compact power transmission system having no power loss.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a transmission system of a hybrid electric vehicle having advantages of achieving EV mode, continuous mode and parallel mode including direct-coupling and OD by disposing two motor/generators and two clutches on an input shaft.

In addition, various aspects of the present invention have been made in an effort to provide a transmission system of a hybrid electric vehicle having further advantages of enhancing fuel economy by not using clutches at modes other than parallel mode.

In addition, various aspects of the present invention have been made in an effort to provide a transmission system of a hybrid electric vehicle having further advantages of achieving speed-reduction gear ratio for starting an engine and speed-reduction gear ratio of a drive motor/generator through a planetary gear set.

In addition, various aspects of the present invention have been made in an effort to provide a transmission system of a hybrid electric vehicle having further advantages of achieving Overdrive (OD) using a planetary gear set. Therefore, a conventional output gear set for achieving the OD can be removed and a length of a transmission may be shortened.

A transmission system of a hybrid electric vehicle according to various aspects of the present invention may include: an input shaft connected to an engine; first and second motor/generators disposed on a transmission housing; a first planetary gear set disposed on the input shaft and having three rotation elements, wherein one rotation element is connected to the transmission housing, another rotation element is connected to the first motor/generator, and the other rotation element is connected to the input shaft; a second planetary gear set disposed on the input shaft and having three rotation elements, wherein one rotation element is connected to the transmission housing, another rotation element is connected to the second motor/generator, and the other rotation element is operated as an output element; an output gear connected to the other rotation element of the second planetary gear set; and a first clutch selectively connecting the input shaft to the output gear.

The transmission system may further include a second clutch selectively connecting another rotation element of the first planetary gear set to the output gear.

The first planetary gear set may be a single pinion planetary gear set including a first sun gear, a first planet carrier, and a first ring gear as rotation elements thereof, wherein the first sun gear is fixed to the transmission housing, the first planet carrier is directly connected to the input shaft and is selectively connected to the output gear through the first clutch, and the first ring gear is directly connected to the first motor/generator and is selectively connected to the output gear through the second clutch.

The second planetary gear set may be a single pinion planetary gear set including a second sun gear, a second planet carrier, and a second ring gear as rotation elements thereof, wherein the second sun gear is directly connected to the second motor/generator, the second planet carrier is directly connected to the output gear, and the second ring gear is fixed to the transmission housing.

The transmission system may further include a reduction speed gear unit including an intermediate shaft disposed in parallel with the input shaft and disposed between the output gear and a final reduction gear of a differential apparatus so as to transmit torque of the output gear to the differential apparatus.

The reduction speed gear unit may include: an intermediate gear disposed on the intermediate shaft and externally meshed with the output gear; and a drive gear disposed on the intermediate shaft and externally meshed with the final reduction gear of the differential apparatus.

The second planetary gear set may be a single pinion planetary gear set including a second sun gear, a second planet carrier, and a second ring gear as rotation elements thereof, wherein the second sun gear is directly connected to the second motor/generator, the second planet carrier is fixed to the transmission housing, and the second ring gear is directly connected to the output gear.

A transmission system of a hybrid electric vehicle according to various aspects of the present invention may include: an input shaft connected to an engine; first and second motor/generators disposed on a transmission housing; a first planetary gear set disposed on the input shaft and having three rotation elements, wherein one rotation element is connected to the transmission housing, another rotation element is connected to the first motor/generator, and the other rotation element is connected to the input shaft; a second planetary gear set disposed on the input shaft and having three rotation elements, wherein one rotation element is connected to the transmission housing, another rotation element is connected to the second motor/generator, and the other rotation element is operated as an output element; an output gear connected to the other rotation element of the second planetary gear set; and one clutch selectively connecting another rotation element of the first planetary gear set to the output gear.

The transmission system may further include another clutch selectively connecting the input shaft to the output gear.

The first planetary gear set may be a single pinion planetary gear set including a first sun gear, a first planet carrier, and a first ring gear as rotation elements thereof, wherein the first sun gear is fixed to the transmission housing, the first planet carrier is directly connected to the input shaft and is selectively connected to the output gear through another clutch, and the first ring gear is directly connected to the first motor/generator and is selectively connected to the output gear through the one clutch.

The second planetary gear set may be a single pinion planetary gear set including a second sun gear, a second planet carrier, and a second ring gear as rotation elements thereof, wherein the second sun gear is directly connected to the second motor/generator, the second planet carrier is directly connected to the output gear, and the second ring gear is fixed to the transmission housing.

The transmission system may further include a reduction speed gear unit including an intermediate shaft disposed in parallel with the input shaft and disposed between the output gear and a final reduction gear of a differential apparatus so as to transmit torque of the output gear to the differential apparatus.

The reduction speed gear unit may include: an intermediate gear disposed on the intermediate shaft and externally meshed with the output gear; and a drive gear disposed on the intermediate shaft and externally meshed with the final reduction gear of the differential apparatus.

The second planetary gear set may be a single pinion planetary gear set including a second sun gear, a second planet carrier, and a second ring gear as rotation elements thereof, wherein the second sun gear is directly connected to the second motor/generator, the second planet carrier is fixed to the transmission housing, and the second ring gear is directly connected to the output gear.

A transmission system of a hybrid electric vehicle according to various aspects of the present invention may include: an input shaft connected to an engine; first and second motor/generators disposed on a transmission housing; a first planetary gear set including first, second, and third rotation elements, wherein the first rotation element is fixed to the transmission housing, the second rotation element is connected to the input shaft, and the third rotation element is connected to the first motor/generator; a second planetary gear set including fourth, fifth, and sixth rotation elements, wherein the fourth rotation element is connected to the second motor/generator, the fifth rotation element is operated as an output element, and the sixth rotation element is fixed to the transmission housing; an output gear connected to the fifth rotation element of the second planetary gear set; a first clutch selectively connecting the input shaft to the output gear; and a second clutch selectively connecting the third rotation element of the first planetary gear set to the output gear.

The first planetary gear set may be a single pinion planetary gear set, wherein a first sun gear is the first rotation element, a first planet carrier is the second rotation element, and a first ring gear is the third rotation element.

The second planetary gear set may be a single pinion planetary gear set, wherein a second sun gear is the fourth rotation element, a second planet carrier is the fifth rotation element, and a second ring gear is the sixth rotation element.

The second planetary gear set is a single pinion planetary gear set, wherein a second sun gear is the fourth rotation element, a second ring gear is the fifth rotation element, and a second planet carrier is the sixth rotation element.

The transmission system may further include a reduction speed gear unit including an intermediate shaft disposed in parallel with the input shaft and disposed between the output gear and a final reduction gear of a differential apparatus so as to transmit torque of the output gear to the differential apparatus.

The reduction speed gear unit may include: an intermediate gear disposed on the intermediate shaft and externally meshed with the output gear; and a drive gear disposed on the intermediate shaft and externally meshed with the final reduction gear of the differential apparatus.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary transmission system of a hybrid electric vehicle according to the present invention.

FIG. 2 is an operational chart of friction elements at each mode applied to an exemplary transmission system of a hybrid electric vehicle according to the present invention.

FIG. 3 is a schematic diagram for illustrating flow of power at EV mode in an exemplary transmission system of a hybrid electric vehicle according to the present invention.

FIG. 4 is a schematic diagram for illustrating flow of power at continuous mode in an exemplary transmission system of a hybrid electric vehicle according to the present invention.

FIG. 5 is a schematic diagram for illustrating flow of power at direct-coupling of parallel mode in an exemplary transmission system of a hybrid electric vehicle according to the present invention.

FIG. 6 is a schematic diagram for illustrating flow of power at OD of parallel mode in an exemplary transmission system of a hybrid electric vehicle according to the present invention.

FIG. 7 is a schematic diagram of an exemplary transmission system of a hybrid electric vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining various embodiments will be omitted, and the same constituent elements are denoted by the same reference numerals in this specification.

In the detailed description, ordinal numbers are used for distinguishing constituent elements having the same terms, and have no specific meanings.

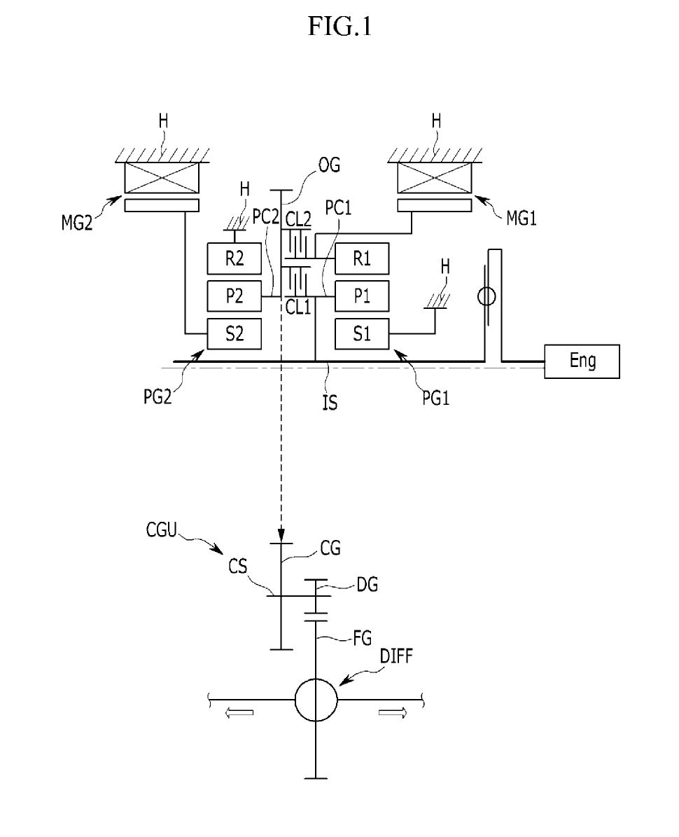

FIG. 1 is a schematic diagram of a transmission system of a hybrid electric vehicle according to various embodiments of the present invention.

Referring to FIG. 1, a transmission system of a hybrid electric vehicle according to various embodiments of the present invention changes torques of engine Eng and first and second motor/generators MG1 and MG2 according to running state of a vehicle and outputs the changed torque through an output gear OG.

The transmission system includes the first and second motor/generators MG1 and MG2, first and second planetary gear sets PG1 and PG2, an output gear OG, first and second clutches CL1 and CL2 and a reduction speed gear unit CGU.

The first motor/generator MG1 and the second motor/generator MG2 are independent power sources and are operated as a motor and a generator.

The first motor/generator MG1 is directly connected to one rotation element of the first planetary gear set PG1 so as to be operated as a start motor for starting the engine or to be operated as a generator that generates electricity by torque of the engine transmitted through the one rotation element.

The second motor/generator MG2 is directly connected to one rotation element of the second planetary gear set PG2 so as to be operated as a motor supplying torque to the one rotation element or to be operated as a generator that generates electricity by torque of the one rotation element.

For this purpose, a stator of the first motor/generator MG1 and a stator of the second motor/generator MG2 are fixed to a transmission housing H, and a rotor of the first motor/generator MG 1 and a rotor of the second motor/generator MG2 are connected respectively to the one rotation element of the first planetary gear set PG1 and the one rotation element of the second planetary gear set PG2.

The first and second motor/generators MG1 and MG2 and the first and second planetary gear sets PG1 and PG2 are disposed on the input shaft IS.

In addition, the first and second clutches CL1 and CL2 may be conventional multi-plate friction elements of wet type that are operated by hydraulic pressure, and are frictional elements selectively connecting a rotation element with another rotation element.

Hereinafter, the transmission system of the hybrid electric vehicle according to various embodiments of the present invention will be described in further detail.

The first planetary gear set PG1 is a single pinion planetary gear set, and includes a first sun gear S1, a first planet carrier PC1 rotatably supporting a first pinion P1 externally meshed with the first sun gear S1, and a first ring gear R1 internally meshed with the first pinion P1 as rotation elements thereof.

The second planetary gear set PG2 is a single pinion planetary gear set, and includes a second sun gear S2, a second planet carrier PC2 rotatably supporting a second pinion P2 externally meshed with the second sun gear S2, and a second ring gear R2 internally meshed with the second pinion P2 as rotation elements thereof.

The rotation elements of the first planetary gear set PG1 are not directly connected to the rotation elements of the second planetary gear set PG2, the first planetary gear set PG1 is positioned on the input shaft IS closest to the engine Eng, and the second planetary gear set PG2 is positioned on the input shaft IS farthest from the engine Eng.

The first sun gear S1 is fixed to the transmission housing H, the first planet carrier PC1 is connected to the input shaft IS, and the first ring gear R1 is connected to the first motor/generator MG1.

That is, the first motor/generator MG1 is connected to the first ring gear R1 of the first planetary gear set PG1 so as to drive the first ring gear R1 or to be operated as the generator by torque of the first ring gear R1.

The second sun gear S2 is connected to the second motor/generator MG2, the second planet carrier PC2 is connected to the output gear OG so as to reduce speed of the second motor/generator MG2 and output the reduced speed, and the second ring gear R2 is fixed to the transmission housing H.

That is, the second motor/generator MG2 is connected to the second sun gear S2 of the second planetary gear set PG2 so as to drive the second sun gear S2 or to be operated as the generator by torque of the second sun gear S2.

The first clutch CL1 is disposed between the input shaft IS and the output gear OG and selectively connects the input shaft IS and the output gear OG. Therefore, the torque of the engine Eng is directly input to the output gear OG.

The second clutch CL2 is disposed between the first ring gear R1 of the first planetary gear set PG1 and the output gear OG and selectively connects the first ring gear R1 of the first planetary gear set PG1 and the output gear OG. Therefore, speed of the engine Eng is increased by the first planetary gear set PG1 and the increased speed is input to the output gear OG.

Herein, the output gear OG and the first and second clutches CL1 and CL2 are disposed between the first and second planetary gear sets PG1 and PG2.

In addition, the output gear OG transmits torque to a final reduction gear FG of a differential apparatus DIFF through the reduction speed gear unit CGU.

The reduction speed gear unit CGU includes an intermediate shaft CS disposed between the input shaft IS and the differential apparatus DIFF and in parallel with the input shaft IS, an intermediate gear CG disposed at an end portion of the intermediate shaft CS and externally meshed with the output gear OG, and a drive gear DG disposed at the other end portion of the intermediate shaft CS and externally meshed with the final reduction gear FG of the differential apparatus DIFF.

At this time, since a diameter of the intermediate gear CG is larger than that of the drive gear DG, speed of the output gear OG is reduced and the reduced speed is transmitted to the final reduction gear FG.

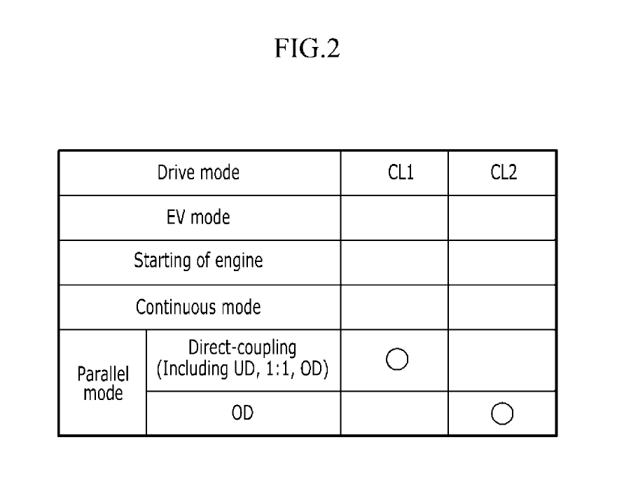

FIG. 2 is an operational chart of friction elements at each mode applied to a transmission system of a hybrid electric vehicle according to various embodiments of the present invention.

Referring to FIG. 2, the transmission system of the hybrid electric vehicle according to various embodiments of the present invention can achieve EV mode, continuous mode, and parallel mode including direct-coupling and OD.

That is, the first and second clutches CL1 and CL2 are released at the EV mode and the continuous mode, the first clutch CL1 is operated at the direct-coupling of the parallel mode, and the second clutch CL2 is operated at the OD of the parallel mode.

At this time, under drive, direct-coupling drive and over drive can be achieved according to gear ratios of the intermediate gear CG and the drive gear DG of the reduction speed gear unit CGU engaged with the output gear OG at the direct-coupling of the parallel mode.

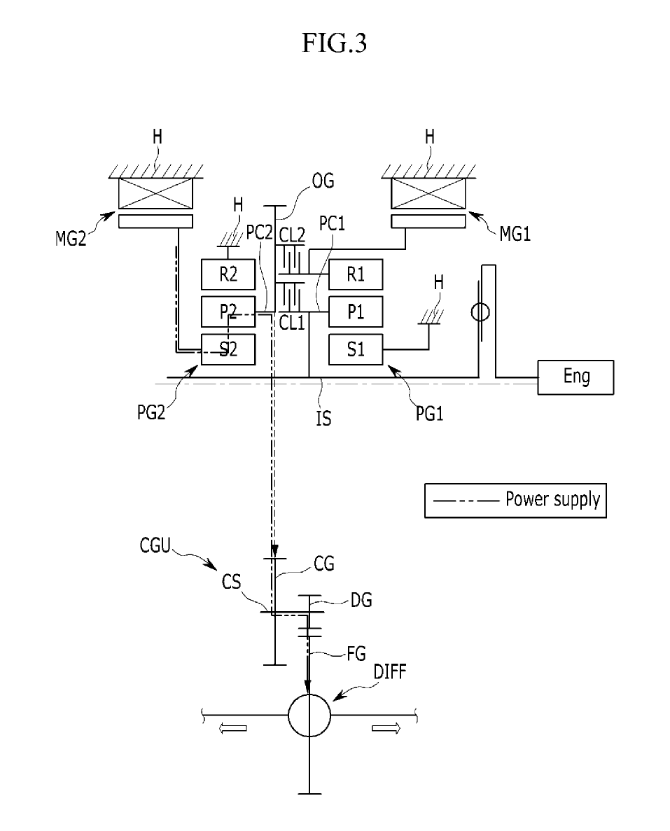

Hereinafter, flow of torque at each mode in the transmission system of the hybrid electric vehicle according to various embodiments of the present invention will be described, referring to FIG. 3 to FIG. 6.

FIG. 3 is a schematic diagram for illustrating flow of power at EV mode in a transmission system of a hybrid electric vehicle according to various embodiments of the present invention.

Referring to FIG. 3, all the clutches are released at the EV mode.

The engine Eng is stopped, the first planetary gear set PG1 is not directly involved in a shift, and the speed of the second motor/generator MG2 is reduced by the second planetary gear set PG2. The reduced speed is transmitted to the output gear OG. Therefore, electric continuously variable shift may be achieved at the EV mode.

That is, the second ring gear R2 is operated as a fixed element, the torque of the second motor/generator MG2 is input to the second sun gear S2, and the reduced speed is output through the second planet carrier PC2 that is the output element.

That is, the torque of the second motor/generator MG2 is transmitted to the final reduction gear FG of the differential apparatus DIFF through the output gear OG connected to the second planet carrier PC2, the intermediate gear CG, and the drive gear DG.

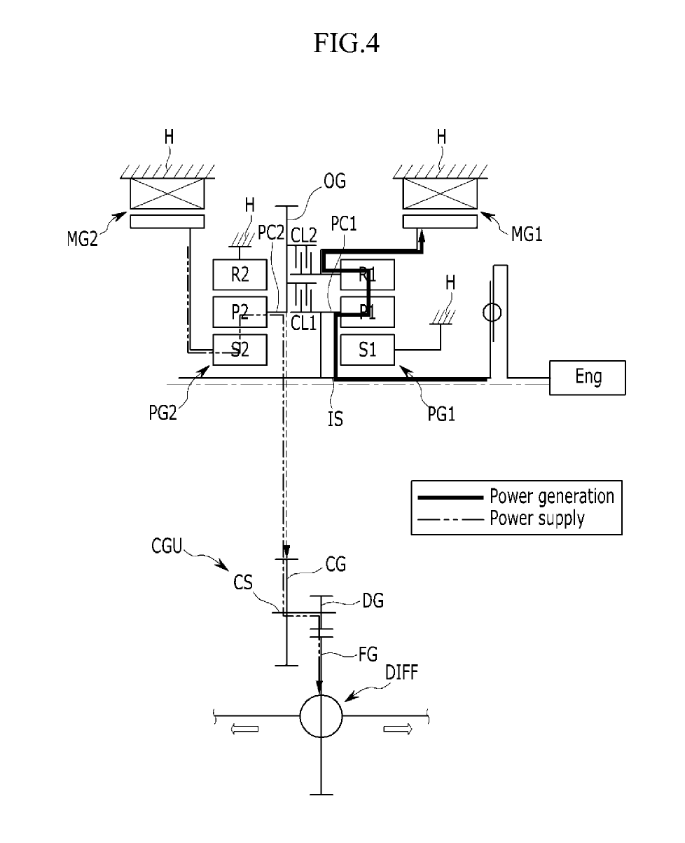

FIG. 4 is a schematic diagram for illustrating flow of power at continuous mode in a transmission system of a hybrid electric vehicle according to various embodiments of the present invention.

Referring to FIG. 4, all the clutches are released at the continuous mode.

If the engine Eng is started at the EV mode, the continuous mode is achieved. Electricity generated by the first motor/generator MG1 is supplied to the second motor/generator MG2 as drive power at the continuous mode.

At this time, the engine Eng is started by the first motor/generator MG1.

That is, if the first motor/generator MG1 is operated and the torque of the first motor/generator MG1 is input to the first ring gear R1 of the first planetary gear set PG1, the first sun gear S1 is operated as the fixed element and increased torque is output through the first planet carrier PC1.

Torque for starting the engine Eng is supplied to the engine Eng through the input shaft IS connected to the first planet carrier PC1, and the engine Eng is started.

After the engine Eng is started, the first motor/generator MG1 is not operated and the first motor/generator MG1 generates electricity by receiving the increased speed of the engine Eng through the first ring gear R1.

All the planetary gear sets are not directly involved in the shift, and the electric continuously variable shift may be achieved by output of the second motor/generator MG2 through the second planetary gear set PG2 at the continuous mode.

At this time, the first planetary gear set PG1 is involved only in the starting of the engine Eng and power generation of the first motor/generator MG1.

That is, the second ring gear R2 is operated as the fixed element and the torque of the second motor/generator MG2 is input to the second sun gear S2 at the continuous mode as well as the EV mode. Therefore, the torque is output through the second planet carrier PC2 that is the output element.

The torque of the second motor/generator MG2 is transmitted to the final reduction gear FG of the differential apparatus DIFF through the output gear OG connected to the second planet carrier PC2, the intermediate gear CG, and the drive gear DG.

At this time, the second motor/generator MG2 uses the electricity generated by the first motor/generator MG1 as the drive power. In addition, remaining electricity is charged in the battery.

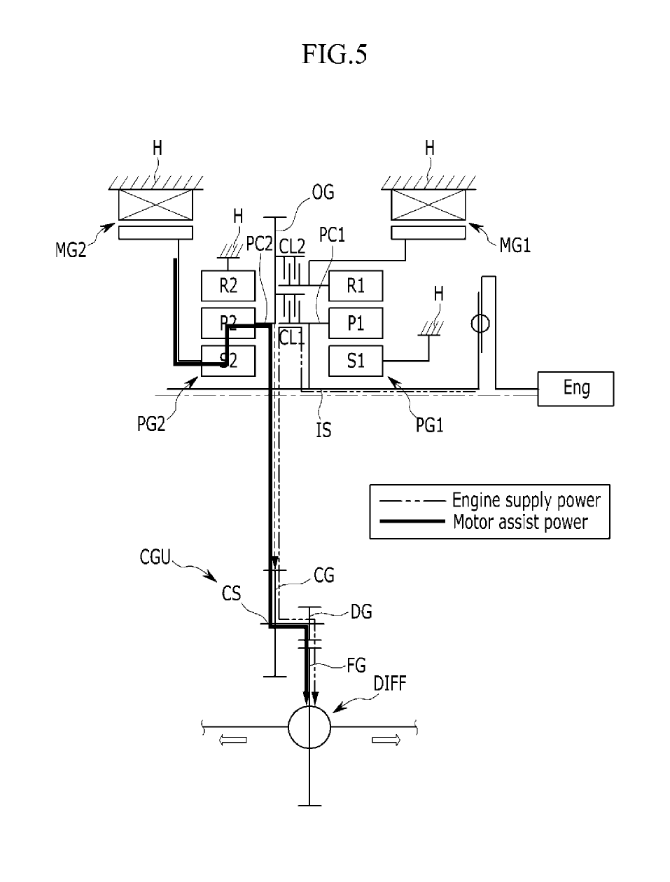

FIG. 5 is a schematic diagram for illustrating flow of power at direct-coupling of parallel mode in a transmission system of a hybrid electric vehicle according to various embodiments of the present invention.

Referring to FIG. 5, the first clutch CL1 is operated at the direct-coupling of the parallel mode.

The torque of the engine Eng is used as main power and the torque of the second motor/generator MG2 is used as auxiliary power at the direct-coupling of the parallel mode.

That is, the torque of the engine Eng is supplied as the main power to the output gear OG through the input shaft IS by operation of the first clutch CL1, and the torque of the second motor/generator MG2 is supplied to the output gear OG through the second planet carrier PC2 as the auxiliary power.

At this time, a portion of the torque of the engine Eng may be involved in the power generation of the first motor/generator MG 1.

The planetary gear set is not directly involved in the shift, and the electric continuously variable shift may be achieved by the torque of the engine Eng transmitted to the output gear OG through the input shaft IS and the torque of the second motor/generator MG2 transmitted to the output gear OG through the second planetary gear set PG2 at the direct-coupling of the parallel mode.

As described above, the torques of the second motor/generator MG2 and the engine Eng input to the output gear OG are transmitted to the final reduction gear FG of the differential apparatus DIFF through the intermediate gear CG and the drive gear DG.

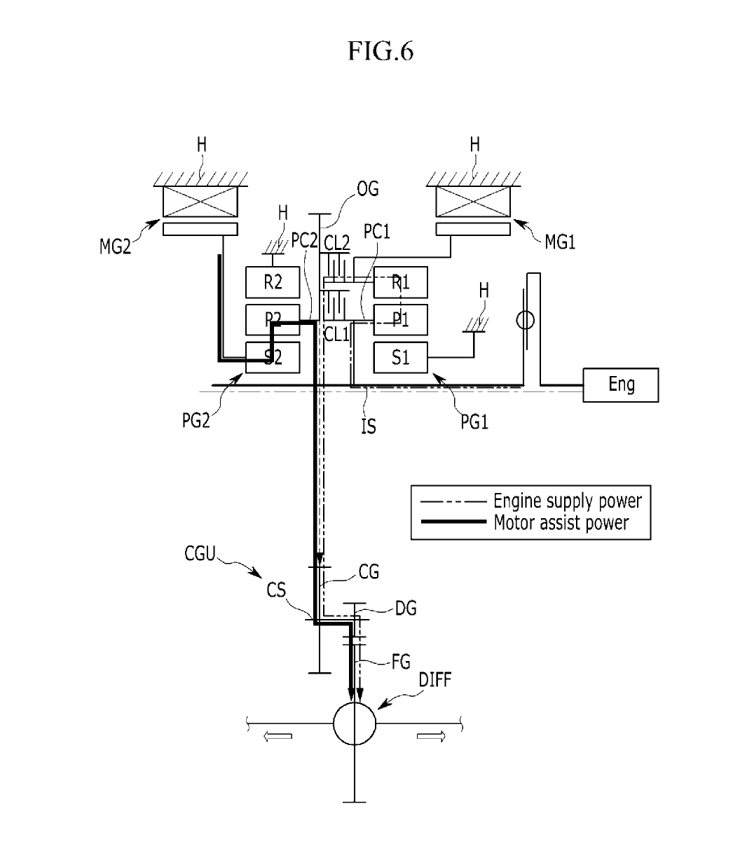

FIG. 6 is a schematic diagram for illustrating flow of power at OD of parallel mode in a transmission system of a hybrid electric vehicle according to various embodiments of the present invention.

Referring to FIG. 6, the second clutch CL2 is operated at the OD of the parallel mode.

The torque of the engine Eng is used as the main power and the torque of the second motor/generator MG2 is used as the auxiliary power at the OD of the parallel mode.

That is, if the torque of the engine Eng is input to the first planet carrier PC1 of the first planetary gear set PG1 through the input shaft IS by operation of the second clutch CL2, the first sun gear S1 is operated as the fixed element and the increased speed is transmitted to the output gear OG as the main power through the first ring gear R1. Simultaneously, the torque of the second motor/generator MG2 is transmitted to the output gear OG as the auxiliary power through the second planet carrier PC2.

At this time, the portion of the torque of the engine Eng may be involved in the power generation of the first motor/generator MG1.

All the planetary gear sets are not directly involved in the shift, and the electric continuously variable shift may be achieved by the torque of the engine Eng transmitted to the output gear OG through the input shaft IS and the first planetary gear set PG1 and the torque of the second motor/generator MG2 transmitted to the output gear OG through the second planetary gear set PG2 at the OD of the parallel mode.

As described above, the torques of the second motor/generator MG2 and the engine Eng input to the output gear OG are transmitted to the final reduction gear FG of the differential apparatus DIFF through the intermediate gear CG and the drive gear DG.

Therefore, all of the engine Eng, the first motor/generator MG1 and the second motor/generator MG2 can generate driving torque, the first motor/generator MG1 can generate electricity by using the torque of the engine Eng, and continuous gear ratios required in the vehicle can be formed by control of the second motor/generator MG2. Therefore, fuel economy may be improved.

That is, the EV mode, the continuous mode and the parallel mode including the direct-coupling and the OD can be achieved by disposing two motor/generators MG1 and MG2 and two clutches CL1 and CL2 on the input shaft.

In addition, since clutches are not used at modes other than the parallel mode, operating pressure applied to the clutches can be minimized and fuel economy may be improved.

In addition, since the direct-coupling is added in the parallel mode, fuel economy may be enhanced and capacity of the first motor/generator MG1 may be reduced.

In addition, since the torque of the second motor/generator MG2 is increased by the second planetary gear set PG2, demand torque of the second motor/generator MG2 can be reduced. Therefore, a length of the transmission may be shortened and cost of PE components may be reduced.

In addition, since the OD is achieved by using the first planetary gear set PGs, a conventional output gear set for achieving the OD can be removed and the length of the transmission may be shortened.

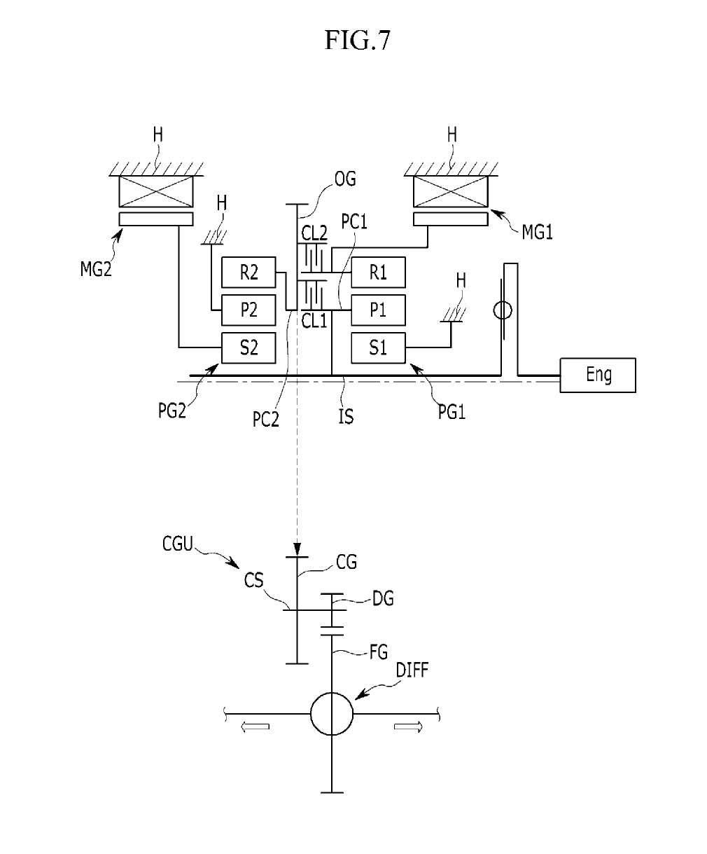

Meanwhile, FIG. 7 is a schematic diagram of a transmission system of a hybrid electric vehicle according to various embodiments of the present invention.

Referring to FIG. 7, the second planet carrier PC2 is connected to the transmission housing H so as to be operated as the fixed element, and the second ring gear R2 is connected to the output gear OG so as to be operated as the output element in the transmission system of the hybrid electric vehicle according to various embodiments of the present invention.

If the torque of the second motor/generator MG2 is input to the second sun gear S2, the second planet carrier PC2 is operated as the fixed element and the second ring gear R2 outputs the reduced speed according to the gear ratio.

Since functions of the transmission system of FIG. 7 are the same as those described above, except the rotation elements of the second planetary gear set PG2 consisting of the fixed element and the output element, detailed description thereof will be omitted.

The EV mode, the continuous mode and the parallel mode including the direct-coupling and the OD can be achieved by disposing two motor/generators and two clutches on the input shaft according to various embodiments of the present invention.

In addition, since clutches are not used at modes other than the parallel mode, operating pressure applied to the clutches can be minimized and fuel economy may be improved.

In addition, since the direct-coupling is added in the parallel mode, fuel economy may be enhanced and capacity of the first motor/generator may be reduced.

In addition, since the torque of the second motor/generator is increased by the second planetary gear set, demand torque of the second motor/generator can be reduced. Therefore, a length of the transmission may be shortened and cost of PE components may be reduced.

In addition, since the OD is achieved by using the first planetary gear set PGs, a conventional output gear set for achieving the OD can be removed and the length of the transmission may be shortened.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission system of a hybrid electric vehicle comprising:
an input shaft connected to an engine;
first and second motor/generators on a transmission housing;
a first planetary gear set on the input shaft and having three rotation elements, wherein one rotation element is connected to the transmission housing, another rotation element is connected to the first motor/generator, and the other rotation element is connected to the input shaft;
a second planetary gear set on the input shaft and having three rotation elements, wherein one rotation element is connected to the transmission housing, another rotation element is connected to the second motor/generator, and the other rotation element is operated as an output element;
an output gear connected to the other rotation element of the second planetary gear set; and
a first clutch selectively connecting the input shaft to the output gear.

2. The transmission system of claim 1, further comprising a second clutch selectively connecting another rotation element of the first planetary gear set to the output gear.

3. The transmission system of claim 2, wherein the first planetary gear set is a single pinion planetary gear set including a first sun gear, a first planet carrier, and a first ring gear as rotation elements thereof, and
wherein the first sun gear is fixed to the transmission housing, the first planet carrier is directly connected to the input shaft and is selectively connected to the output gear through the first clutch, and the first ring gear is directly connected to the first motor/generator and is selectively connected to the output gear through the second clutch.

4. The transmission system of claim 2, wherein the second planetary gear set is a single pinion planetary gear set including a second sun gear, a second planet carrier, and a second ring gear as rotation elements thereof, and
wherein the second sun gear is directly connected to the second motor/generator, the second planet carrier is directly connected to the output gear, and the second ring gear is fixed to the transmission housing.

5. The transmission system of claim 1, further comprising a reduction speed gear unit including an intermediate shaft parallel with the input shaft and between the output gear and a final reduction gear of a differential apparatus so as to transmit torque of the output gear to the differential apparatus.

6. The transmission system of claim 5, wherein the reduction speed gear unit comprises:
an intermediate gear on the intermediate shaft and externally meshed with the output gear; and
a drive gear on the intermediate shaft and externally meshed with the final reduction gear of the differential apparatus.

7. The transmission system of claim 2, wherein the second planetary gear set is a single pinion planetary gear set including a second sun gear, a second planet carrier, and a second ring gear as rotation elements thereof, and
wherein the second sun gear is directly connected to the second motor/generator, the second planet carrier is fixed to the transmission housing, and the second ring gear is directly connected to the output gear.

8. A transmission system of a hybrid electric vehicle comprising:
an input shaft connected to an engine;
first and second motor/generators disposed on a transmission housing;
a first planetary gear set on the input shaft and having three rotation elements, wherein one rotation element is connected to the transmission housing, another rotation element is connected to the first motor/generator, and the other rotation element is connected to the input shaft;
a second planetary gear set on the input shaft and having three rotation elements, wherein one rotation element is connected to the transmission housing, another rotation element is connected to the second motor/generator, and the other rotation element is operated as an output element;
an output gear connected to the other rotation element of the second planetary gear set; and
one clutch selectively connecting another rotation element of the first planetary gear set to the output gear.

9. The transmission system of claim 8, further comprising another clutch selectively connecting the input shaft to the output gear.

10. The transmission system of claim 9, wherein the first planetary gear set is a single pinion planetary gear set including a first sun gear, a first planet carrier, and a first ring gear as rotation elements thereof, and
wherein the first sun gear is fixed to the transmission housing, the first planet carrier is directly connected to the input shaft and is selectively connected to the output gear through another clutch, and the first ring gear is directly connected to the first motor/generator and is selectively connected to the output gear through the one clutch.

11. The transmission system of claim 9, wherein the second planetary gear set is a single pinion planetary gear set including a second sun gear, a second planet carrier, and a second ring gear as rotation elements thereof, and
wherein the second sun gear is directly connected to the second motor/generator, the second planet carrier is directly connected to the output gear, and the second ring gear is fixed to the transmission housing.

12. The transmission system of claim 8, further comprising a reduction speed gear unit including an intermediate shaft parallel with the input shaft and between the output gear and a final reduction gear of a differential apparatus so as to transmit torque of the output gear to the differential apparatus.

13. The transmission system of claim 12, wherein the reduction speed gear unit comprises:
an intermediate gear on the intermediate shaft and externally meshed with the output gear; and
a drive gear on the intermediate shaft and externally meshed with the final reduction gear of the differential apparatus.

14. The transmission system of claim 9, wherein the second planetary gear set is a single pinion planetary gear set including a second sun gear, a second planet carrier, and a second ring gear as rotation elements thereof, and
wherein the second sun gear is directly connected to the second motor/generator, the second planet carrier is fixed to the transmission housing, and the second ring gear is directly connected to the output gear.

15. A transmission system of a hybrid electric vehicle comprising:
an input shaft connected to an engine;
first and second motor/generators disposed on a transmission housing;
a first planetary gear set including first, second, and third rotation elements, wherein the first rotation element is fixed to the transmission housing, the second rotation element is connected to the input shaft, and the third rotation element is connected to the first motor/generator;
a second planetary gear set including fourth, fifth, and sixth rotation elements, wherein the fourth rotation element is connected to the second motor/generator, the fifth rotation element is operated as an output element, and the sixth rotation element is fixed to the transmission housing;
an output gear connected to the fifth rotation element of the second planetary gear set;
a first clutch selectively connecting the input shaft to the output gear; and
a second clutch selectively connecting the third rotation element of the first planetary gear set to the output gear.

16. The transmission system of claim 15, wherein the first planetary gear set is a single pinion planetary gear set, and
wherein a first sun gear is the first rotation element, a first planet carrier is the second rotation element, and a first ring gear is the third rotation element.

17. The transmission system of claim 15, wherein the second planetary gear set is a single pinion planetary gear set, and
wherein a second sun gear is the fourth rotation element, a second planet carrier is the fifth rotation element, and a second ring gear is the sixth rotation element.

18. The transmission system of claim 15, wherein the second planetary gear set is a single pinion planetary gear set, and
wherein a second sun gear is the fourth rotation element, a second ring gear is the fifth rotation element, and a second planet carrier is the sixth rotation element.

19. The transmission system of claim 15, further comprising a reduction speed gear unit including an intermediate shaft parallel with the input shaft and between the output gear and a final reduction gear of a differential apparatus so as to transmit torque of the output gear to the differential apparatus.

20. The transmission system of claim 19, wherein the reduction speed gear unit comprises:
an intermediate gear on the intermediate shaft and externally meshed with the output gear; and
a drive gear on the intermediate shaft and externally meshed with the final reduction gear of the differential apparatus.
